(19) United States
(12) Patent Application Publication
(10) Pub. No.: US 2014/0335336 A1
(43) Pub. Date: Nov. 13, 2014

(54) Laminate Bearing And Methods Of Manufacturing The Same

(71) Applicant: Saint-Gobain Performance Plastics Corporation, Aurora, OH (US)

(72) Inventors: Hongyan Wang, Shanghai (CN); Xiaoye Liu, Shanghai (CN); Shuming Zhang, Shanghai (CN); Juichiro Yamaguchi, Tokyo (JP); Wei Xu, Shanghai (CN); Jinxin Zhu, Shanghai (CN)

(73) Assignee: Saint-Gobain Performance Plastics Corporation, Aurora, OH (US)

(21) Appl. No.: 14/258,780

(22) Filed: Apr. 22, 2014

Related U.S. Application Data
(60) Provisional application No. 61/867,781, filed on Aug. 20, 2013.

(30) Foreign Application Priority Data
May 8, 2013 (CN) 201310167365.9
Jun. 7, 2013 (CN) 201310226449.5

(51) Int. Cl. F16C 33/20

(52) U.S. Cl. CPC F16C 33/203; F16C 33/208
USPC 428/214; 156/60; 428/461; 428/337; 428/339

(57) ABSTRACT

A maintenance-free and self-lubricant slide bearing comprising a metal support, an intermediate adhesive layer applied directly thereto and a sliding layer based on UHMWPE. The bearing laminate is characterized by a high peel-strength and does not require a surface pre-treatment of the metal support to achieve a strong bonding of the UHMWPE sliding layer to the metal support. The preferred adhesive in the intermediate layer is an anhydride-grafted polyethylene. The invention further includes a process of making the bearing laminate.

### CROSS-REFERENCE TO RELATED APPLICATIONS

The present application claims priority from Chinese Patent Application No. 201310167365.9, filed May 8, 201, entitled “MULTI-LAYER BEARING LAMINATE INCLUDING A UHMWPE SLIDE LAYER”, naming as inventors Hongyan Wang et al., and Chinese Patent Application No. 201310226449.5, filed Jun. 7, 2013, entitled “MULTI-LAYER BEARING LAMINATE INCLUDING A UHMWPE SLIDE LAYER”, naming as inventors Hongyan Wang et al., and U.S. Provisional Patent Application No. 61/867,781, filed Aug. 20, 2013, entitled “LAMINATE BEARING AND METHODS OF MANUFACTURING THE SAME”, naming as inventors Hongyan Wang et al., which applications are incorporated by reference herein in their entirety.

### FIELD OF THE DISCLOSURE

The disclosure relates to a maintenance-free and self-lubricant slide bearing comprising a metal support, an intermediate layer comprising an anhydride grafted polyolefin applied directly thereto and an ultra high molecular weight polyethylene (UHMWPE)-based sliding layer applied to the intermediate layer.

### BACKGROUND

Maintenance-free slide bearings which comprise a layer structure having a metallic support material, an intermediate layer and a sliding layer applied thereto are used in a wide variety of technical fields, for example in the field of automotive and bicycle engineering.

EP 0394518 A1 describes a multilayer plain bearing material in which the metallic support material preferably consists of cold-rolled steel on which a layer of a copolymer of perfluoro(alkyl vinyl ether) and tetrafluoroethylene has been applied as intermediate layer. A sliding layer composed of a PTFE compound material is in turn applied to the intermediate layer. In this plain bearing material, the intermediate layer has the function of establishing firm adhesion of the sliding layer to the support material. In order firstly to ensure adhesion of the intermediate layer to the support material, the surface of the metallic support material in this known plain bearing material has to be pre-treated in a suitable manner by wet chemical means. The best results appear to be achieved by chromating of the surface of the metallic support. However, this process is problematical for a variety of reasons, including environmental issues and others. As such, there is a continued need for improved maintenance free slide bearings.

An alternative material to PTFE in the slide layer may be UHMWPE, which is known for having a low coefficient of friction, a high impact strength, solvent resistance, low water absorption, and noise- and shock abatement properties. Because of the low surface energy of UHMWPE, however, it provides difficulties to adhere it to metal surfaces, and a pre-treatment of the metal backing appears to be unavoidable in order to improve the strength of an applied adhesive.

Therefore, it would be advantageous if a slide bearing could be produced that would not require extensive pre-treatment of the metal support without sacrificing adhesive strength between the metal support and the sliding layer.

### SUMMARY

In an embodiment, a maintenance-free slide bearing can include a metal support, an intermediate adhesive layer applied directly thereto, and a sliding layer directly applied to the intermediate layer. The intermediate adhesive includes a grafted polyolefin according to formula (I)

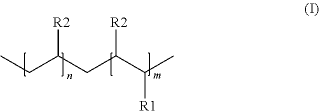

wherein R₁ includes an alkyl or cycloalkyl group comprising an acid anhydride group or at least two polar functional groups, and R₂ is H, C₁-C₅ Alkyl or phenyl.

In another embodiment, a process for producing a maintenance-free slide bearing includes joining the intermediate layer and the sliding layer. The joining can be over their entire area of the metal support. The joining can be under pressure and/or can include introduction of heat.

Other features and advantages of the present invention will be set forth in the detailed description that follows, and will be apparent, in part, from the description or may be learned by practice of the invention. The invention will be realized and attained by the methods and devices particularly pointed out in the written description and claims hereof. This description is being given solely by way of example and with reference to the appended drawings.

### BRIEF DESCRIPTION OF THE DRAWINGS

The present disclosure may be better understood, and its numerous features and advantages made apparent to those skilled in the art by referencing the accompanying drawings.

FIG. 1 shows an exemplary slide bearing including a schematic sectional view of a cross cut; and

FIG. 2 shows a graph of experimental results of peel-strength tests on slide bearings according to an embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B is true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources directed to bearing laminates.

The present invention provides a maintenance-free bearing article which includes a metal support, an intermediate adhesive layer directly applied to the metal support, and a sliding layer directly applied to the intermediate layer. In one embodiment, excellent adhesion of the sliding layer to the support material is ensured over a long term. In another embodiment, production does not require ecologically problematical processes for surface pre-treatment.

The intermediate adhesive layer of the bearing article comprises a grafted polyolefin according to formula (I)

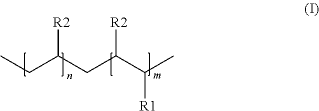

wherein R1 includes an alkyl or cycloalkyl group comprising an acid anhydride group or at least two polar functional groups, and R2 is H, C₁-C₅ Alkyl or phenyl. In one embodiment, the R₁ alkyl group can include an acid anhydride group or at least two polar functional groups. In another embodiment, the R₁ cycloalkyl group can include an acid anhydride group or at least two polar functional groups. In one particular embodiment, R₁ may include the following structures:

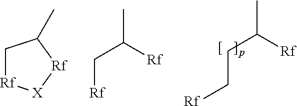

wherein Rf can be CO, C(O)H, C(OH), COOH, CONH₂, OH, or halogen; X can O or NH; and p is an integer between 1 and 6.

In a preferred embodiment, the grafted polyolefin is grafted polyethylene, such as anhydride grafted polyethylene. In a most preferred embodiment, the anhydride grafted polyethylene is polyethylene grafted with maleic anhydride (PE-g-MAH). Accordingly, the adhesive contained in the intermediate layer can include the following structure:

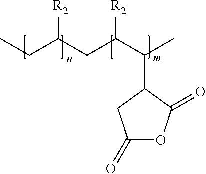

wherein R₂ has the same assignment as described above for formula (I).

The bearing article of the present invention is characterized by an excellent adhesion of the UHMWPE layer to the metal support, provided by the grafted polyolefin adhesive according to formula (I). The excellent adhesion may be characterized by a peel strength of at least about 45 N/cm, such as at least about 50 N/cm, at least about 55 N/cm, at least about 60 N/cm, at least about 65 N/cm, at least about 70 N/cm. The peel strength may reach values up to about 85 N/cm, such as about 80 N/cm, 75 N/cm, 70 N/cm, 65 N/cm or 60 N/cm.

In embodiments, the grafted polyolefin may have a grafting rate of not higher than 15%, such as not higher than 10%, not higher than 7%, not higher than 5%, not higher than 4%, or not higher than 3%. Furthermore, the grafting rate may be at least 0.5%, at least 1%, at least 2%, at least 3%, at least 5%, or at least 8%.

In other embodiments, the grafted polyolefin may have an average molecular weight M_{w} of at least about 1000 g/mol; such as at least about 3,000 g/mol; at least about 5,000 g/mol; at least about 7,000 g/mol, at least about 10,000 g/mol, or at least about 50,000 g/mol. In yet other embodiments, the average molecular weight of the grafted polyolefin may be not higher than about 150,000 g/mol, such as not higher than about 100,000 g/mol, not higher than about 50,000 g/mol, not higher than about 20,000 g/mol, not higher than about 15,000 g/mol; not higher than about 10,000 g/mol, not higher than about 7,000 g/mol or not higher than about 5,000 g/mol.

In one embodiment, the intermediate adhesive layer may comprise at least 90% by weight of the grafted polyolefin according to formula (I), such as at least 92 wt %, at least 94 wt %, at least 96 wt %, at least 98 wt %, at least 99 wt %, at least 99.5 wt % or even 100 wt %. In a particular embodiment, the intermediate adhesive layer comprises at least 98% PE-g-MAH.

In embodiments, the thickness of the adhesive layer can be between about 0.01 mm and about 1.5 mm. For example, the thickness may be at least about 0.01 mm, such as at least about 0.03 mm, at least about 0.5 mm, at least about 0.7 mm or at least about 0.9 mm. Furthermore, the thickness may be not greater than about 1.5 mm, such as not greater than about 1.3 mm, not greater than about 1.0 mm, not greater than about 0.8 mm, or not greater than about 0.6 mm.

In an embodiment, the intermediate adhesive layer may contain one or more fillers. Fillers can, for example, increase and/or improve the thermal conductivity and/or wear properties. The fillers may be fibers, inorganic materials, thermoplastic materials, mineral materials, or mixtures thereof. For example, the fillers may be glass fibers, carbon fibers, aramids, PTFE and PPS fiber, ceramic materials, carbon, glass, graphite, aluminium oxide, molybdenum sulfide, bronze, silicon carbide, polyimide (PI), PTFE, polyamidimide (PAI), polyphenylene sulfide (PPS), polyphenylene sulfone (PPSO2), liquid crystal polymers (LCP), polyether ether ketones (PEEK), aromatic polyesters (Ekonol), wollastonite and barium sulphate. The fillers may be in form of woven fabrics, powders, spheres or fibers.

In a further aspect, the filler content of the intermediate adhesive layer may be at least about 0.1 wt %, such as at least about 0.5 wt %, at least about 1 wt %, at least about 5 wt %, at least about 10 wt %, at least about 20 wt %, or at least about 30 wt %. Moreover, the filler amount may not be greater than about 60 wt %, such as not greater than about 50 wt %, not greater than about 40 wt %, not greater than about 30 wt %, or not greater than about 20 wt %.

The metal support of the bearing article may be aluminum, steel, stainless steel, messing, copper, or bronze. In a preferred embodiment the metal support may be aluminum or steel.

In an embodiment, the thickness of the metal support may be between about 2 mm and about 0.01 mm. For example, the thickness of the metal support may be not greater than about 2 mm, such as not greater than about 1.5 mm, not greater than about 1.3 mm, not greater than about 1.0 mm or not greater than about 0.7 mm. Moreover, the thickness may be at least about 0.01 mm, such as at least about 0.05 mm, at least about 0.1 mm, at least about 0.2 mm, at least about 0.3 mm, at least about 0.4 mm, at least about 0.5 mm, at least about 0.7 mm or at least about 0.9 mm.

The bearing article of the present invention is characterized by excellent adhesion of the UHMWPE sliding layer to the support material caused by the intermediate adhesive layer including the grafted polyolefin of formula (I). Owing to the excellent adhesion, even a non-pre-treated surface of the metal support, in particular aluminum, cold-rolled steel, cold-rolled and subsequently electrolytically zinc-plated steel, or stainless steel may be used, while ecologically problematical and disposal-intensive wet chemical pre-treatment processes, in particular chromating, can be dispensed. Moreover, physical processes for surface pre-treatment (e.g. plasma pre-treatment by corona discharge) as described, for example, in EP 0 848 031 B1, are not longer necessary. The process for producing the slide bearing of the present invention can therefore be carried out at significantly lower costs compared to the prior art.

The metal support used in the slide bearing can have a surface of a varying nature. Owing to the excellent adhesion properties of the adhesive layer comprising the grafted polyolefin, the metal support can have either a smooth surface or a roughened or structured surface (for example, a honeycomb structure). In a preferred embodiment, the surface of the metal support facing the adhesive layer is not roughened. In another preferred embodiment, the surface of the metal support facing the adhesive layer comprises a honeycomb structure.

Corresponding to the varying nature of the metal support surface, the surface roughness Ra of the metal support surface facing the adhesive layer may be at least about 0.01 micron, at least about 0.02 micron, at least about 0.05 micron, at least about 0.1 micron, at least about 0.5 micron, at least about 1 micron, at least about 2 microns, at least about 5 microns, at least about 10 microns, at least about 20 microns, at least about 50 microns, at least about 100 microns, at least about 200 microns, or at least about 400 microns.

In other embodiments, the surface roughness Ra may be less than about 400 microns, less than about 200 microns, less than about 100 microns, less than about 50 microns, less than about 25 microns, less than about 20 microns, less than about 15 microns, less than about 10 microns, less than about 5 microns, less than about 3 microns, less than about 2 microns, or even less than about 1 micron.

In yet another embodiment, the metal support may have a surface roughness Ra in the range from about 0.1 micron to about 400 microns, such as from about 0.5 micron to about 100 microns, or from about 1 micron to about 50 microns.

The sliding layer in direct contact with the intermediate adhesive layer is based on ultrahigh molecular weight polyethylene (UHMWPE). In embodiments, the sliding layer can be configured to be air-permeable, perforated, or porous. Such texture in combination with a filler or lubricant improves thermal conductivity.

The thickness of the UHMWPE sliding layer may be between about 0.01 mm to about 1.5 mm. In embodiments, the thickness is not greater than about 1.5 mm, such as not greater than about 1.3 mm, not greater than about 1.0 mm, not greater than about 0.8 mm, or not greater than about 0.6 mm. In other embodiments, the thickness of the UHMWPE layer is at least about 0.01 mm, such as at least about 0.03 mm, at least about 0.5 mm, at least about 0.7 mm or at least about 0.8 mm.

In embodiments, the UHMWPE sliding layer may further comprises one or more fillers, pigments and/or dyes. The fillers may be added, for example, to increase and/or improve the thermal conductivity and/or the wear properties. Non-limiting examples of usable fillers may be carbon, glass, graphite, aluminium oxide, molybdenum sulfide, bronze, silicon carbide, polyimide (PI), polyamidimide (PAI), polyphenylene sulfide (PPS), polyphenylene sulfone (PPSO2), liquid crystal polymers (LCP), polyether ether ketones (PEEK), polyethersulfone (PES), polyetherketone (PEK), and aromatic polyesters (Ekonol), glass fibers, carbon fibers, and aramids, wollastonite and barium sulfate. In a preferred embodiment, the fillers are carbon, graphite, or ekonol. The fillers may be in the form of woven fabrics, powders, spheres, or fibers.

In further embodiments the filler amount of the UHMWPE layer is at least about 0.1 wt %, such as at least about 0.5 wt %, at least about 1 wt %, at least about 5 wt %, at least about 10 wt %, at least about 20 wt %, or at least about 30 wt % based on total weight of the UHMWPE layer. Furthermore, the filler amount may not be greater than about 60 wt %, such as not greater than about 50 wt %, not greater than about 40 wt %, not greater than about 30 wt %, or not greater than about 20 wt % based on the total weight of the UHMWPE layer.

In other embodiments, the average molecular weight M_{w} of the UHMWPE may be at least about 1 million, such as at least about 1.5 million, at least about 2.0 million or at least about 3.0 million.

In embodiments, the bearing material of the present invention may have a thickness ratio between the intermediate adhesive layer and the UHMWPE sliding layer in a range of about 1:10 to about 2:1, such as 1:5 to 1:1, or 1:3 to 1:1.

In a further embodiment, the bearing material may have a thickness ratio between the metal support and the thickness of the complete laminate in a range of about 1:10 to 1:2, such as 1:5 to 1:2 or 1:3 to 1:2.

In embodiments the maintenance-free slide bearing of the present invention may be manufactured by providing a metal support layer, an adhesive layer and a UHMWPE layer and joining these layers by placing the adhesive layer intermediate the metal support layer and the UHMWPE layer and applying pressure and/or heat treatment at various process stages.

In a preferred embodiment, the UHMWPE layer and the adhesive layer are in form of sheet-like materials and coextruded on a surface of the metal support.

In another preferred embodiment, the metal support, the adhesive layer and the UHMWPE layer are each provided in form of sheet-like materials and joined together at the same point and laminated. In this process, the metal support as well the intermediate adhesive layer and the UHMWPE sliding layer are each rolled off a roll as continuous material and joined to one another under pressure and at elevated temperature in a laminating roller apparatus. A laminating temperature may be in a range of about 150° C. to about 230° C., and an applied pressure may be between about 0.1 MPa and about 10 MPa, such as between about 0.5 MPa and about 5 MPa, or between about 1 MPa and about 3 MPa.

In yet another embodiment, the grafted polyolefin adhesive material is directly applied on the pre-heated metal support and rolled, and thereafter the UHMWPE material is directly applied on the adhesive layer and rolled. The temperature of the heated metal support may be about 150° C. to about 230° C.

To achieve further-improved adhesion of the intermediate layer to the metal support together with improved corrosion properties of the metal support, an embodiment of the process provides for the surface of the metal support to be roughed and/or surface-upgraded (e.g. by electrolytic zinc-plating) before application of the intermediate layer. Furthermore, the surface of the metal support can be increased by mechanical structuring, for example by brushing, sandblasting, or embossing of a structure (e.g., a honey comb structure).

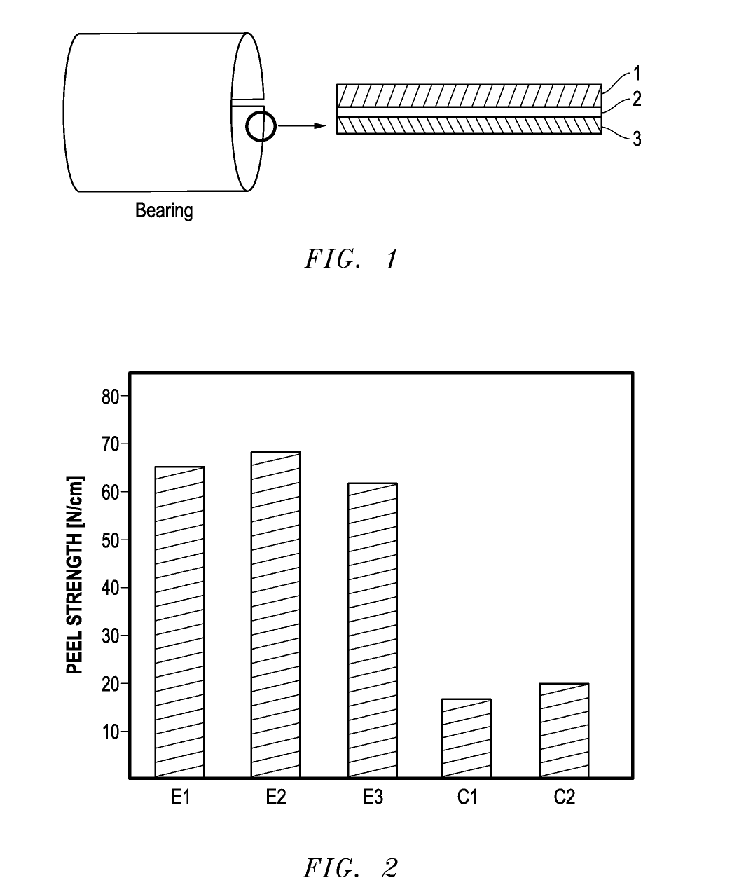

The structure of an exemplary maintenance-free slide bearing is shown in FIG. 1. Here, the metal support is denoted by 1, while 2 denotes the intermediate adhesive layer and 3 denotes the UHMWPE sliding layer applied thereto. In an embodiment, the improved adhesive strength can be determined by means of a 180° peel test using sandwich laminates.

In an embodiment, the bearing laminate of the present invention is implemented in an assembly. The assembly comprises a first member, wherein said first member may be a cavity, and a second member, wherein said second member may be an elongated body located inside the first member. The bearing laminate is located between said first member and said second member.

Many different aspects and embodiments of the laminate of the present disclosure are possible. Some of those aspects and embodiments are described herein. After reading this specification, skilled artisans will appreciate that those aspects and embodiments are only illustrative and do not limit the scope of the present invention. Embodiments may be in accordance with any one or more of the items listed below.

Item 1. A laminate comprising a metal support; an intermediate adhesive layer in direct contact with the metal support, the adhesive layer comprising a grafted polyolefin according to formula (I)

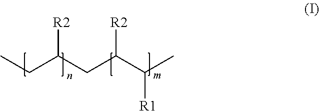

wherein R1 includes an alkyl or cycloalkyl group comprising an acid anhydride group or at least two polar functional groups, and R2 is H, C₁-C₅ Alkyl or phenyl; and an ultrahigh molecular weight polyethylene (UHMWPE) layer in direct contact with the intermediate layer, wherein an average peel strength of the UHMWPE layer at room temperature is at least about 55 N/cm.

Item 2. A bearing article formed from a laminate, the laminate comprising: a metal support; an intermediate adhesive layer in direct contact with the metal support, the adhesive layer comprising a grafted polyolefin according to formula (I)

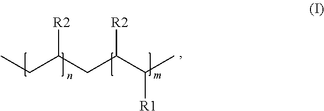

wherein R1 includes an alkyl or cycloalkyl group comprising an acid anhydride group or at least two polar functional groups, and R2 is H, C₁-C₅ Alkyl or phenyl; and an ultrahigh molecular weight polyethylene (UHMWPE) layer in direct contact with the intermediate layer.

Item 3. The laminate or bearing article according to item 2, wherein an average peel-strength of the UHMWPE layer at room temperature is at least about 45 N/cm, such as at least about 50 N/cm, at least about 55 N/cm, at least about 60 N/cm, at least about 65 N/cm or at least about 70 N/cm.

Item 4. The laminate or bearing article according to items 1 or 2, wherein the grafted polyolefin is grafted polyethylene.

Item 5. The laminate or bearing article according to items 1 or 2, wherein R1 includes

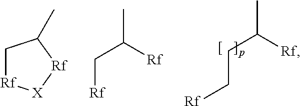

wherein Rf is CO, C(O)H, COOH, CONH₂, OH, or halogen; X is O or NH; and p is 1-6.

Item 6. The laminate or bearing article according to item 5, wherein the grafted polyolefin is anhydride grafted polyethylene.

Item 7. The laminate or bearing article according to item 6, wherein the anhydride grafted polyethylene is a polyethylene grafted with maleic anhydride (PE-g-MAH).

Item 8. The laminate or bearing according to items 1 or 2, wherein the grafted polyolefin has a grafting rate of not higher than 15%, such as not higher than 10%, not higher than 7%, not higher than 5%, not higher than 4% or not higher than 3%.

Item 9. The laminate or bearing article according to items 1 or 2, wherein the grafted polyolefin has a grafting rate of at least 0.5%, such as at least 1%, at least 2%, at least 3%, at least 5%, or at least 8%.

Item 10. The laminate or bearing article according to items 1 or 2, wherein an average molecular weight M_{w} of the grafted polyolefin is at least about 1,000 g/mol, such as at least about 3,000 g/mol, at least about 5,000 g/mol, at least about 7,000 g/mol, or at least about 10,000 g/mol.

Item 11. The laminate or bearing article according to items 1 or 2, wherein an average molecular weight M_{w} of the grafted polyolefin is not higher than about 50,000 g/mol, such as not higher than about 20,000 g/mol, not higher than about 15,000 g/mol, not higher than about 10,000 g/mol, not higher than about 7,000 g/mol or not higher than about 5,000 g/mol.

Item 12. The laminate or bearing article according to items 1 or 2, wherein an average molecular weight M_{w} of the UHMWPE is at least 1.5 million g/mol, such as at least 2.0 million g/mol or at least 3.0 million g/mol.

Item 13. The laminate or bearing article according to items 1 or 2, wherein a thickness of the metal support is at least about 0.01 mm, such as at least about 0.1 mm, at least about 0.2 mm, at least about 0.3 mm, at least about 0.4 mm, at least about 0.5 mm, at least about 0.7 mm or at least about 0.9 mm.

Item 14. The laminate or bearing article according to items 1 or 2, wherein a thickness of the metal support is not greater that about 2 mm, such as not greater than about 1.5 mm, not greater than about 1.3 mm, not greater than about 1.0 mm or not greater than about 0.7 mm.

Item 15. The laminate or bearing article according to items 1 or 2, wherein a thickness of the adhesive layer is at least about 0.01 mm, such as at least about 0.03 mm, at least about 0.5 mm, at least about 0.7 mm or at least about 0.9 mm.

Item 16. The laminate or bearing article according to items 1 or 2, wherein a thickness of the adhesive layer is not greater than about 1.5 mm, such as not greater than about 1.3 mm, not greater than about 1.0 mm, not greater than about 0.8 mm, or not greater than about 0.6 mm.

Item 17. The laminate or bearing article according to items 1 or 2, wherein a thickness of the UHMWPE layer is at least about 0.01 mm, such as at least about 0.03 mm, at least about 0.5 mm, at least about 0.7 mm or at least about 0.8 mm.

Item 18. The laminate or bearing article according to items 1 or 2, wherein a thickness of the UHMWPE layer is not greater than about 1.5 mm, such as not greater than about 1.3 mm, not greater than about 1.0 mm, not greater than about 0.8 mm, or not greater than about 0.6 mm.

Item 19. The laminate or bearing material according to items 1 or 2, wherein a thickness ratio between the intermediate adhesive layer and the UHMWPE layer is within a range of about 1:10 to about 2:1, such as 1:5 to 1:1, or 1:3 to 1:1.

Item 20. The laminate or bearing material according to items 1 or 2, wherein a ratio of a thickness of the metal support to a thickness of the complete laminate is within a range of about 1:10 to 1:2.

Item 21. The laminate or bearing article according to items 1 or 2, wherein the metal support is aluminum, steel, stainless steel, messing, copper, or bronze.

Item 22. The laminate or bearing article according to item 21, wherein the metal is aluminum.

Item 23. The laminate according to claim 1 or 2, wherein a surface of the metal layer facing the adhesive layer is not roughened.

Item 24. The laminate according to item 23, wherein the surface of the metal layer facing the adhesive layer has a surface roughness Ra of less than about 10 microns, such as less than about 5 microns, less than about 3 microns, less than about 1 micron, or less than about 0.5 micron.

Item 25. The laminate or bearing article according to items 1 or 2, wherein a surface of the metal layer facing the adhesive layer comprises a honey comb structure surface relief.

Item 26. The laminate or bearing article according to items 1 or 2, wherein a surface of the metal layer facing the adhesive layer is a roughened surface.

Item 27. The laminate or bearing article according to items 1 or 2, wherein the UHMWPE layer further comprises a filler, pigment and/or dye.

Item 28. The laminate or bearing article according to item 27, wherein the filler amount is at least about 0.1 wt %, such as at least about 0.5 wt %, at least about 1 wt %, at least about 5 wt %, at least about 10 wt %, at least about 20 wt %, or at least about 30 wt %.

Item 29. The laminate or bearing article according to item 27, wherein the filler amount is not greater than about 60 wt %, such as not greater than about 50 wt %, not greater than about 40 wt %, not greater than about 30 wt %, or not greater than about 20 wt %.

Item 30. The laminate or bearing article of item 27, wherein the fillers are fibers, inorganic materials, thermoplastic materials, mineral materials, or mixtures thereof.

Item 31. The laminate or bearing article of item 30, wherein the fibers include glass fibers, carbon fibers, PTFE fiber, PPS fiber or aramids.

Item 32. The laminate or bearing article of item 30, wherein the inorganic materials include ceramic materials, carbon, glass, graphite, aluminum oxide, molybdenum sulfide, bronze, or silicon carbide.

Item 33. The laminate or bearing article according to item 30, wherein the filler is graphite, carbon, PTFE or ekonol.

Item 34. The laminate or bearing article of item 30, wherein the inorganic materials are in the form of woven fabrics, powders, spheres, or fibers.

Item 35. The laminate or bearing article according to items 1 or 2, wherein the intermediate adhesive layer consists essentially of the grafted polyolefin.

Item 36. The laminate or bearing article according to claim 35, wherein the intermediate adhesive layer consists essentially of polyethylene grafted with maleic anhydride (PE-g-MAH).

Item 37. The laminate or bearing article according to items 1 or 2, wherein the intermediate adhesive layer further comprises a filler.

Item 38. The laminate or bearing article according to item 37, wherein the filler amount is at least about 0.1 wt %, such as at least about 0.5 wt %, at least about 1 wt %, at least about 5 wt %, at least about 10 wt %, at least about 20 wt %, or at least about 30 wt %.

Item 39. The laminate or bearing article according to item 37, wherein the filler amount is not greater than about 60 wt %, such as not greater than about 50 wt %, not greater than about 40 wt %, not greater than about 30 wt %, or not greater than about 20 wt %.

Item 40. The laminate or bearing article of item 37, wherein the fillers are fibers, inorganic materials, thermoplastic materials, mineral materials, or mixtures thereof.

Item 41. The laminate or bearing article of item 37, wherein the fibers include glass fibers, carbon fibers or aramids.

Item 42. The laminate or bearing article of item 37, wherein the inorganic materials include ceramic materials, carbon, glass, graphite, aluminum oxide, molybdenum sulfide, bronze, or silicon carbide.

Item 43. The laminate or bearing articles of item 37, wherein the inorganic materials are in the form of woven fabrics, powders, spheres, or fibers.

Item 44. A method of making a laminate comprising: providing a metal support layer, an adhesive layer and a UHMWPE layer; joining the metal support layer, the adhesive layer and the UHMWPE layer by placing the adhesive layer intermediate the metal support layer and the UHMWPE layer; and applying pressure and/or heat treatment at various process stages, wherein the adhesive layer comprises an anhydride grafted polyolefin, and the peel strength of the UHMWPE layer of the bearing composite is at least 55 N/cm.

Item 45. The method of item 44, wherein the UHMWPE layer and the adhesive layer are in form of sheet-like materials and coextruded on a surface of the metal support layer.

Item 46. The method of item 44, wherein the metal support layer, the adhesive layer and the UHMWPE layer are each in form of sheet-like material and are joined together at the same point and laminated.

Item 47. The method of item 44, wherein the adhesive film is directly applied on the metal support layer and rolled, and thereafter the UHMWPE layer is directly applied on the adhesive layer and rolled.

Item 48. The method of item 44, further comprising applying a honey-comb surface structure on a surface of the metal support layer facing the adhesive layer.

Item 49. The method of item 44, wherein the anhydride grafted polyolefin is polyethylene grafted with maleic anhydride (PE-g-MAH).

Item 50. An assembly comprising: a first member, wherein said first member is a cavity; a second member, wherein said second member is an elongated body located inside the first member; a bearing located between said first member and said second member; and wherein said bearing is formed from a laminate comprising: a metal support; an intermediate adhesive layer in direct contact with the metal support, the adhesive layer comprising a grafted polyolefin according to formula (I)

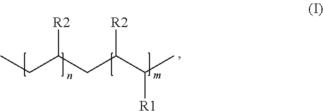

wherein R1 includes an alkyl or cycloalkyl group comprising an acid anhydride group or at least two polar functional groups, and R2 is H, C₁-C₅ Alkyl or phenyl.

Item 51. The assembly of item 50, wherein an average peel strength peel-strength of the UHMWPE comprising layer is at least about 45 N/cm, such as at least about 50 N/cm, at least about 55 N/cm, at least about 60 N/cm, at least about 65 N/cm, or at least about 70 N/cm.

Item 52. The assembly of item 50, wherein the grafted polyolefin is grafted polyethylene.

Item 53. The assembly of item 50, wherein R1 includes

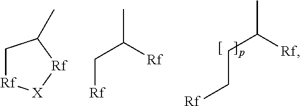

wherein Rf is CO, C(O)H, COOH, CONH₂, OH, or halogen; X is O or NH; and p is 1-6.

Item 54. The assembly of item 50, wherein the grafted polyolefin is anhydride grafted polyethylene.

Item 55. The assembly of item 54, wherein the anhydride grafted polyethylene is a polyethylene grafted with maleic anhydride (PE-g-MAH).

Item 56. An assembly comprising: a first member, wherein said first member is a cavity; a second member, wherein said second member is an elongated body located inside the first member; a bearing located between said first member and said second member; and wherein said bearing is formed from a laminate comprising: a metal support; an intermediate adhesive layer in direct contact with the metal support, the adhesive layer comprising polyethylene grafted with maleic anhydride (PE-g-MAH); and

an ultrahigh molecular weight polyethylene (UHMWPE) layer in direct contact with the intermediate layer, wherein the UHMWPE comprises a filler selected from the group consisting of graphite, carbon and ekonol, and wherein an average peel strength of the UHMWPE layer is at least about 45 N/cm.

### EXAMPLES

The following non-limiting examples illustrate the present invention.

Table 1 and FIG. 2 show peel strength results of 3 examples with varying metal backing: E1) steel backing; E2) aluminium backing with honeycomb structure and E3) aluminium backing without honeycomb structure. Except with regard to the added honeycomb surface structure, the surfaces of the metal backings were all untreated (no mechanical roughening or acid etching treatment). The adhesive layer in each of examples E1), E2), and E3) contained 100 wt % PE-g-MAH and had a thickness of 0.3 mm. The UHMWPE sliding layer had a thickness of 0.3 mm, and the metal support had a thickness of 0.5 mm.

Table 1 and FIG. 2 further show peel strength results of comparative examples C1 and C2, including adhesive layers made from well known adhesives but not falling under the grafted polyolefin according to the present invention, such as modified PA (comparative example C1) and EVA (comparative examples C2). The metal backing in both comparative examples was steel.

The peel strength in all experiments was measured by conducting a 180° peel test as described in ASTM D3330, which is incorporated herein in its entirety. Test stripes of specimens had a three-layer structure: metal backing, adhesive layer and sliding layer. The width of the test stripes was 25 mm.

As the experimental results show, all examples including PE-g-MAH as adhesive for joining the metal support and UHMWPE layer show surprisingly high peel strength values between about 62 to 69 N/cm, whereby aluminum with honeycomb surface structure showed the highest peel strength.

In comparison, modified PA and EVA resulted in an unacceptable adhesion of the UHMWPE layer on the metal backing, and accordingly have much lower peel strength values.

TABLE 1

| | E1 | E2 | E3 | C1 | C2 |
|---|---|---|---|---|---|
| Metal backing | steel | aluminum + | aluminum | steel | steel |
| | | honeycomb | | | |
| | | surf. structure | | | |
| Adhesive | PE-g-MAH | PE-g-MAH | PE-g-MAH | Modified PA | EVA |
| Slide layer | UHMWPE | UHMWPE | UHMWPE | UHMWPE | UHMWPE |
| Average Peel | 65.7 | 68.7 | 62.2 | 17 | 20 |
| Strength | | | | | |
| [N/cm] | | | | | |

Tribological Tests:

Tribological tests have been conducted on bushings with steel backing, wherein before laminating, the thickness of the steel backing was 0.4 mm, the thickness of the adhesive layer was 0.3 mm and the thickness of the pure UHMWPE layer was 0.3 mm. The thickness of the complete laminate after laminating was 0.8 mm. The tribological tests were conducted with different PV values.

| | | PV Value | | | | |
|---|---|---|---|---|---|---|
| Bushing with an ID of | | 0.21 MPa, | 0.6 MPa, | 4.8 MPa, | 15 MPa, | 70 MPa, |
| 25.04~25.10 mm | | 0.540 m/s | 0.26 m/s | 0.058 m/s | 0.02 m/s | 0.0065 m/s |
| 1 | Friction | 0.291 | 0.256 | 0.195 | 0.146 | 0.045 |
| | Coefficient | | | | | |
| 2 | Friction | 0.272 | 0.230 | 0.165 | 0.127 | 0.005 |
| | Coefficient | | | | | |

Slide bearings according to the present disclosure can be prepared in a vast number of very different shapes and sizes. The smallest bearing, also called a pico bearing, is only a few μm in height compared to bearings for other applications that could be up to 500 mm.

Slide bearings of the present disclosure can include plane bearings, annular bearings, bushings, balljoint bearings (half spheres), plain bearings, axial bearings, thrust bearings, linear bearings, bearing shells, bearing cups, flanging bearings and combinations thereof.

It is advantageous that the bearing of the present disclosure is maintenance free. The term “maintenance-free” describes bearings that do not need to be greased as was the case for bearings in early car doors. Yet, the life time of maintenance-free bearings exceeds the average life time of the product these bearings are incorporated or the life time of conventional bearings applied for the same purpose.

Slide bearings are applied in a broad spectrum of commercial industry ranging from the heavy metal industry to the automotive and bike industry, even into baking industry, laptop/mobile phone hinges, bearings for solar applications and more

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

1. A bearing article formed from a laminate, the laminate comprising:
a metal support;
an intermediate adhesive layer in direct contact with the metal support, the adhesive layer comprising a grafted polyolefin according to formula (I) 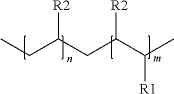
wherein R1 includes an alkyl or cycloalkyl group comprising an acid anhydride
group or at least two polar functional groups, and R2 is H, C₁-C₅ Alkyl or phenyl; and
an ultrahigh molecular weight polyethylene (UHMWPE) layer in direct contact with the intermediate layer.

2. The bearing article of claim 1, wherein an average peel strength of the UHMWPE layer at room temperature is at least 45 N/cm.

3. The bearing article of claim 2, wherein the average peel strength of the UHMWPE layer at room temperature is at least 55 N/cm.

4. The bearing article according to claim 1, wherein the grafted polyolefin is anhydride grafted polyethylene.

5. The bearing article according to claim 4, wherein the anhydride grafted polyethylene is a polyethylene grafted with maleic anhydride (PE-g-MAH).

6. The bearing article according to claim 5, wherein the intermediate adhesive layer consists essentially of polyethylene grafted with maleic anhydride (PE-g-MAH).

7. The bearing article according claim 1, wherein the grafted polyolefin has a grafting rate of not higher than about 15% and at least about 0.5%.

8. The bearing article according to claim 1, wherein a thickness of the metal support is at least about 0.01 mm and not greater that about 2 mm.

9. The bearing article according to claim 1, wherein a thickness of the adhesive layer is at least 0.01 mm and not greater than about 1.5 mm.

10. The bearing article according to claim 1, wherein a thickness of the UHMWPE layer is at least about 0.01 mm and not greater than about 1.5 mm.

11. The laminate or bearing material according to claim 1, wherein a thickness ratio between the intermediate adhesive layer and the UHMWPE layer is within a range of about 1:10 to about 2:1.

12. The bearing article according to claim 1, wherein the metal support is aluminum, steel, stainless steel, messing, copper, or bronze.

13. The bearing article according to claim 1, wherein the UHMWPE layer further comprises a filler, pigment and/or dye.

14. The bearing article according to claim 13, wherein the filler includes graphite, carbon, PTFE, or ekonol in an amount of at least 0.1 wt % and not greater than 60 wt % based on the total weight of the UHMWPE layer.

15. A laminate comprising:
a metal support;
an intermediate adhesive layer in direct contact with the metal support, the adhesive layer comprising a grafted polyolefin according to formula (I) 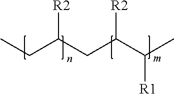
wherein R1 includes an alkyl or cycloalkyl group comprising an acid anhydride
group or at least two polar functional groups, and R2 is H, C₁-C₅ Alkyl or phenyl; and
an ultrahigh molecular weight polyethylene (UHMWPE) layer in direct contact with the intermediate layer,
wherein an average peel strength of the UHMWPE layer at room temperature is at least 55 N/cm.

16. The laminate of claim 15, wherein the grafted polyolefin is anhydride grafted polyethylene having a grafting rate of at least about 0.5% not higher than about 15%.

17. A method of making a laminate comprising:
providing a metal support layer, an adhesive layer and a UHMWPE layer;
joining the metal support layer, the adhesive layer and the UHMWPE layer by placing the adhesive layer intermediate the metal support layer and the UHMWPE layer; and
applying pressure and/or heat treatment at various process stages,
wherein the adhesive layer comprises an anhydride grafted polyolefin, and the peel strength of the UHMWPE layer of the bearing composite is at least 55 N/cm.

18. The method of claim 17, wherein the UHMWPE layer and the adhesive layer are in form of sheet-like materials and coextruded on a surface of the metal support layer.

19. The method of claim 17, wherein the metal support layer, the adhesive layer and the UHMWPE layer are each in form of sheet-like material and are joined together at the same point and laminated.

20. The method of claim 17, wherein the adhesive film is directly applied on the metal support layer and rolled, and thereafter the UHMWPE layer is directly applied on the adhesive layer and rolled.
